(19) United States
(12) Patent Application Publication
(10) Pub. No.: US 2021/0037231 A1
(43) Pub. Date: Feb. 4, 2021

(54) IMAGE PROCESSING APPARATUS, IMAGE PROCESSING METHOD, AND IMAGE PROCESSING PROGRAM

(71) Applicant: SONY CORPORATION, Tokyo (JP)

(72) Inventor: Tooru MASUDA, Tokyo (JP)

(73) Assignee: SONY CORPORATION, Tokyo (JP)

(21) Appl. No.: 16/966,658

(22) PCT Filed: Jan. 29, 2019
(86) PCT No.: PCT/JP2019/002862

§ 371 Date: Jul. 31, 2020

(30) Foreign Application Priority Data
Feb. 9, 2018 (JP) 2018-021830

(51) Int. Cl. H04N 13/282; G06T 7/73; H04N 13/243; H04N 13/122; H04N 13/366

(52) U.S. Cl. CPC H04N 13/282; G06T 7/73; H04N 13/366; H04N 13/122; H04N 13/243

(57) ABSTRACT

An image processing apparatus generates stereo pair full spherical images corresponding to a plurality of positions of a display device, on the basis of two or more viewpoint images for each position determined in accordance with the plurality of positions of the display device, from a plurality of viewpoint images captured at different locations.

### TECHNICAL FIELD

The present technology relates to an image processing apparatus, an image processing method, and an image processing program.

### BACKGROUND ART

In recent years, with the spread of virtual reality (VR) technology, a number of omnidirectional cameras that are capable of capturing images in all 360-degree directions have been announced. This allows full spherical content created to be viewed using a head-mounted display or the like. Then, various proposals have been made for reproducing images of such an omnidirectional camera properly as content (Patent Document 1).

### CITATION LIST

### Patent Document

Patent Document 1: WO 2016/140083 A.

### SUMMARY OF THE INVENTION

### Problems to be Solved by the Invention

At present, stereo omnidirectional cameras commonly known capture images in different directions with two or more cameras, and create left-eye and right-eye spherical images to create a 3D full spherical image. 3D content thus created is designed to reduce failure at the time of stereo viewing in horizontal looking around in a display device such as a head-mounted display. However, in a case where a user wearing a head-mounted display looks in the up-and-down direction, it is impossible to define a left-eye image and a right image because the user can look up and look down from any direction. Thus, the relationship between a right-eye image and a left-eye image breaks down, resulting in failure in left and right stereo views. Therefore, in a case where the position of the display device changes, typically, as it moves upward or downward, parallax is decreased, a picture is used which is not disturbing if the front and rear relationship is reversed, computer graphics (CG) is put on a part, or other measure is taken under the present conditions. This point is an unsolved problem also in the proposals for displaying images of an omnidirectional camera properly as content.

The present technology has been made in view of such a problem. It is an object of the present technology to provide image processing apparatus, an image processing method, and an image processing program that are capable of generating stereo pair full spherical images that reduce failure caused by changes in the position of a display device.

### Solutions to Problems

In order to solve the above-described problem, a first technology is an image processing apparatus generating stereo pair full spherical images corresponding to a plurality of positions of a display device, on the basis of two or more viewpoint images for each position determined in accordance with the plurality of positions of the display device, from a plurality of viewpoint images captured at different locations.

Furthermore, a second technology is an image processing method including generating stereo pair full spherical images corresponding to a plurality of positions of a display device, on the basis of two or more viewpoint images for each position determined in accordance with the plurality of positions of the display device, from a plurality of viewpoint images captured at different locations.

Furthermore, a third technology is an image processing program causing a computer to execute an image processing method including generating stereo pair full spherical images corresponding to a plurality of positions of a display device, on the basis of two or more viewpoint images for each position determined in accordance with the plurality of positions of the display device, from a plurality of viewpoint images captured at different locations.

Furthermore, a fourth technology is an image processing apparatus including a position acquisition unit that acquires a position of a display device, an image determination unit that determines at least one stereo pair full spherical image from a plurality of stereo pair full spherical images generated from a plurality of viewpoint images captured at different locations, on the basis of a plurality of positions of the display device, and an image generation unit that generates a display image to be displayed on the display device on the basis of the determined stereo pair full spherical image.

Furthermore, a fifth technology is an image processing method including acquiring a position of a display device, determining at least one stereo pair full spherical image from a plurality of stereo pair full spherical images generated from a plurality of viewpoint images captured at different locations, on the basis of a plurality of positions of the display device, and generating a display image to be displayed on the display device on the basis of the determined stereo pair full spherical image.

Furthermore, a sixth technology is an image processing program causing a computer to execute an image processing method including acquiring a position of a display device, determining at least one stereo pair full spherical image from a plurality of stereo pair full spherical images generated from a plurality of viewpoint images captured at different locations, on the basis of a plurality of positions of the display device, and generating a display image to be displayed on the display device on the basis of the determined stereo pair full spherical image.

Furthermore, a seventh technology is an image processing apparatus causing a display device to display as a display image at least one stereo pair full spherical image determined on the basis of a position of the display device, from a plurality of stereo pair full spherical images generated according to a plurality of positions of the display device on the basis of two or more viewpoint images selected from a plurality of viewpoint images captured at different locations.

Furthermore, an eighth technology is an image processing method including displaying on a display device as a display image at least one stereo pair full spherical image determined on the basis of a position of the display device, from a plurality of stereo pair full spherical images generated according to a plurality of positions of the display device on the basis of two or more viewpoint images selected from a plurality of viewpoint images captured at different locations.

Moreover, a ninth technology is an image processing program causing a computer to execute an image processing method including displaying on a display device as a display image at least one stereo pair full spherical image determined on the basis of a position of the display device, from a plurality of stereo pair full spherical images generated according to a plurality of positions of the display device on the basis of two or more viewpoint images selected from a plurality of viewpoint images captured at different locations.

### Effects of the Invention

The present technology enables generation of stereo pair full spherical images that reduce failure caused by changes in the position of the display device. Note that the effects described here are not necessarily limiting, and any effect described in the present description may be included.

### BRIEF DESCRIPTION OF DRAWINGS

FIG. 1 is a block diagram illustrating a configuration of an image processing system according to the present technology.

FIG. 2A is an external perspective view illustrating a configuration of an omnidirectional camera, and FIG. 2B is a plan view of the omnidirectional camera.

FIG. 3 is a diagram illustrating a configuration of a cube map (a full spherical image).

FIG. 4 is a perspective view illustrating an external configuration of a head-mounted display.

FIG. 5 is an explanatory diagram of image display by the head-mounted display.

FIG. 6 is a block diagram illustrating a configuration of a content server.

FIG. 7A is a diagram illustrating a position-specific to-be-used camera table, and FIG. 7B is a diagram illustrating looking-up directions from the omnidirectional camera.

FIG. 8 is a flowchart illustrating a flow of stereo pair full spherical image generation processing.

FIG. 9 is a block diagram illustrating a configuration of an output device.

FIG. 10 is a flowchart illustrating a flow of image determination processing.

FIG. 11 is a table illustrating correspondences between rotation information and position patterns.

FIG. 12 is a flowchart illustrating a flow of the image determination processing.

FIG. 13A is an explanatory diagram of a position pattern not defined in the position-specific to-be-used camera table, and FIG. 13B is an explanatory diagram of image composition.

FIG. 14 is a diagram illustrating a change in the position of a user wearing the head-mounted display.

FIG. 15A is a diagram illustrating looking-up directions from the omnidirectional camera in a modification, and FIG. 15B is a diagram illustrating a position-specific to-be-used camera table.

FIG. 16A is one side's view of an omnidirectional camera using wide-angle lenses according to a modification, FIG. 16B is the other side's view of the omnidirectional camera using the wide-angle lenses, and FIG. 16C is a plan view of the omnidirectional camera using the wide-angle lenses.

FIG. 17 is a diagram illustrating the angles of view of the omnidirectional camera according to the modification using the wide-angle lenses.

### MODE FOR CARRYING OUT THE INVENTION

Hereinafter, an embodiment of the present technology will be described with reference to the drawings. Note that the description is made in the following order.

<Embodiment>

[1-1. Configuration of image processing system]

[1-2. Configuration and processing of content server]

[1-3. Configuration and processing of output device]

<2. Modifications>

<1. Embodiment>

[1-1. Configuration of image processing system]

An image processing system 10 includes an omnidirectional camera 100, a content server 200, an output device 300, and a head-mounted display 400. The image processing system 10 performs imaging with the omnidirectional camera 100 including a plurality of cameras that can capture images at a plurality of angles in all directions including up and down and left and right directions, and generates stereo pair full spherical images from the captured images. A stereo pair full spherical image is a pair of images including a left-eye full spherical image and a right-eye full spherical image to produce parallax. Images captured by the plurality of cameras included in the omnidirectional camera 100 are viewpoint images in the claims.

Then, stereo pair full spherical images generated in accordance with various directions are switched according to a direction in which the user wearing the head-mounted display 400 looks (a head position), to be displayed on the head-mounted display 400. This allows viewing, without failure in left and right stereo views in any direction, any angle position. For the horizontal direction, the relationship between a right-eye image and a left-eye image does not break down when the user looks in any direction, and thus left and right stereo views does not fail. Note that in the present technology, according to a direction in which the user wearing the head-mounted display 400 as a display device looks (a head position), a display area in a stereo pair full spherical image is set as a display image. Stereo pair full spherical images include a plurality of full spherical images corresponding to a plurality of positions of the head-mounted display 400.

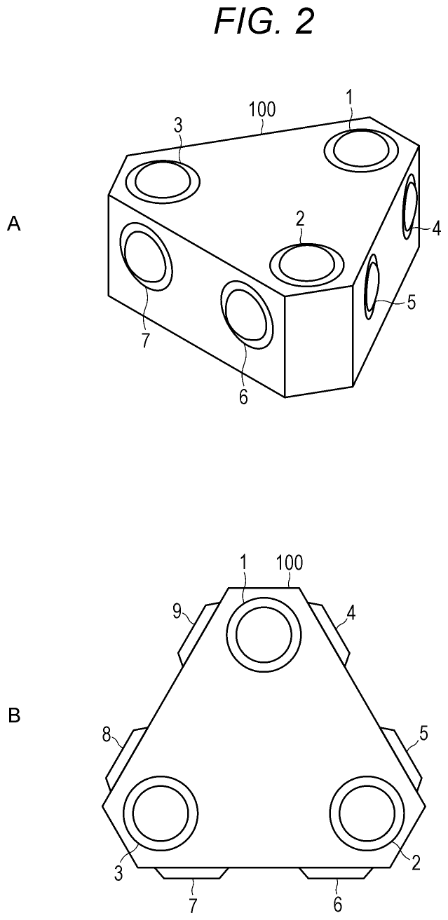

As illustrated in FIG. 2, the omnidirectional camera 100 includes a plurality of cameras. In the present embodiment, the omnidirectional camera 100 includes a total of nine cameras provided at different locations. For explanatory convenience, the cameras included in the omnidirectional camera 100 are referred to as a camera 1, a camera 2, a camera 3, a camera 4, a camera 5, a camera 6, a camera 7, a camera 8, and a camera 9.

The camera 1, the camera 2, and the camera 3 are arranged such that the angles of view of the cameras overlap with lenses directed upward, and are cameras each including a fish-eye lens disposed such that each camera can image the entire area of 90 degrees×90 degrees. As described above, the present technology requires at least three cameras directed upward to generate stereo pair full spherical images corresponding one to at least two directions. This is because images captured by two cameras are required to generate a stereo pair full spherical image corresponding to one direction.

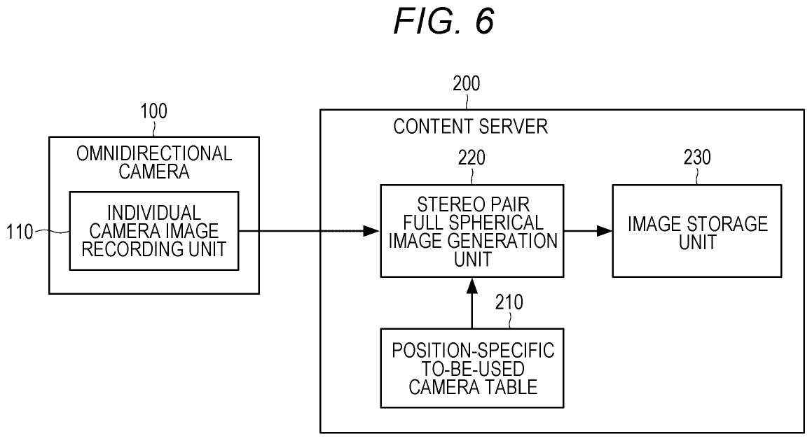

The cameras 4 to 9 each include a lens directed in the horizontal direction. Each camera performs imaging, generating images in frames. As illustrated in FIG. 6, the omnidirectional camera 100 includes an individual camera image recording unit 110 such as a built-in recording medium or a recording medium. Captured images acquired by imaging of the omnidirectional camera 100 are stored in the individual camera image recording unit 110. The omnidirectional camera 100 and the content server 200 are connected by wireless connection such as a wireless local area network (LAN) such as Wi-Fi, or Bluetooth (registered trademark), or wired connection such as a universal serial bus (USB), to pass captured images, various types of data, etc. Alternatively, instead of direct connection, the omnidirectional camera 100 and the content server 200 may exchange a recording medium to pass captured images, various types of data, etc.

The content server 200 selects images to be used for the left and right of a stereo pair from a plurality of images captured by the omnidirectional camera 100, and generates full spherical images. At this time, left and right images corresponding to a plurality of positions determined from the camera arrangement are selected to generate stereo pair full spherical images for the plurality of positions. Consequently, the size of image data and the amount of processing become larger than those of conventional stereo pair full spherical images. However, by dividing an image using, for example, cube mapping, and generating image pairs for a plurality of positions only in a necessary direction, data size and the amount of processing can be reduced.

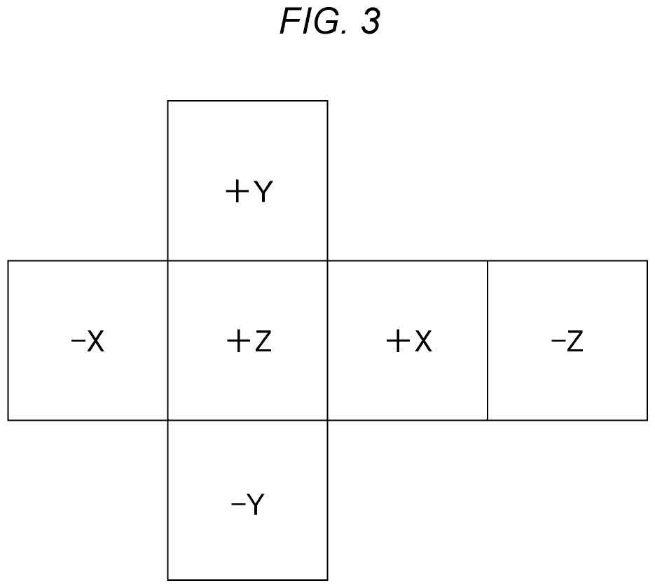

FIG. 3 is a diagram illustrating a configuration of a cube map (a full spherical image) created by cube mapping. The cube map has six squares constituting the faces of an imaginary cube. The faces represent views in different directions (up, down, left, right, front, and back). A full spherical image generated by cube mapping is specifically composed of an image of the −X face, an image of the +Z face, an image of the +X face, an image of the −Z face, an image of the +Y face, and an image of the −Y face. Note that the directions of images generated are not limited to the six faces. In using the cube map, an image in a middle direction such as at 45 degrees obliquely left or at 45 degrees forward and upward is generated for smooth switching from an image in one direction to an image in another direction.

The content server 200 compresses and encodes the generated stereo pair spherical images by a coding system in conformity with Advanced Video Coding (AVC), High Efficiency Video Coding (HEVC)/H.265, or the like, converts them into a stream by, for example, Moving Picture Experts Group-Dynamic Adaptive Streaming over HTTP (MPEG-DASH), and stores it. Then, the content server 200 transmits the MPEG-DASH stream to the output device 300 via the Internet or the like. The MPEG-DASH stream is stored in the output device 300. The MPEG-DASH stream as a piece of content may be entirely downloaded to and stored in the output device 300 and then viewed by the user using the head-mounted display 500. Alternatively, streaming delivery of the MPEG-DASH stream from the content server 200 to the output device 300 may be performed while the user views it. Note that MPEG-DASH is merely an example, and the stream format is not limited to that. Details of image processing by the content server 200 will be described later.

The output device 300 is, for example, a personal computer, a stationary game console, or the like. The output device 300 has a function of outputting video signals generated by executing a preinstalled game program or reproducing an optical disk to the head-mounted display 400 or a display, for example.

The output device 300 receives the MPEG-DASH stream transmitted from the content server 20). Further, the output device 300 receives results of detection a position sensor 410 (an acceleration sensor and a gyro sensor) included in the head-mounted display 400, to obtain information on the orientation, rotation, and inclination of the head-mounted display 400. Moreover, the output device 300 determines the user's line-of-sight vector on the basis of the detection results of the position sensor 410, and determines the user's field of vision on the basis of the user's location and line-of-sight vector.

The output device 300 determines a face corresponding to the user's line-of-sight vector. Then, the output device 300 selects a stream of the face corresponding to the user's line-of-sight vector from the MPEG-DASH stream and decodes it, generating an image in the user's field of vision as a reproduction image. Then, the output device 300 transmits the reproduction image to the head-mounted display 400 via a high-definition multimedia interface (HDMI) (registered trademark) cable.

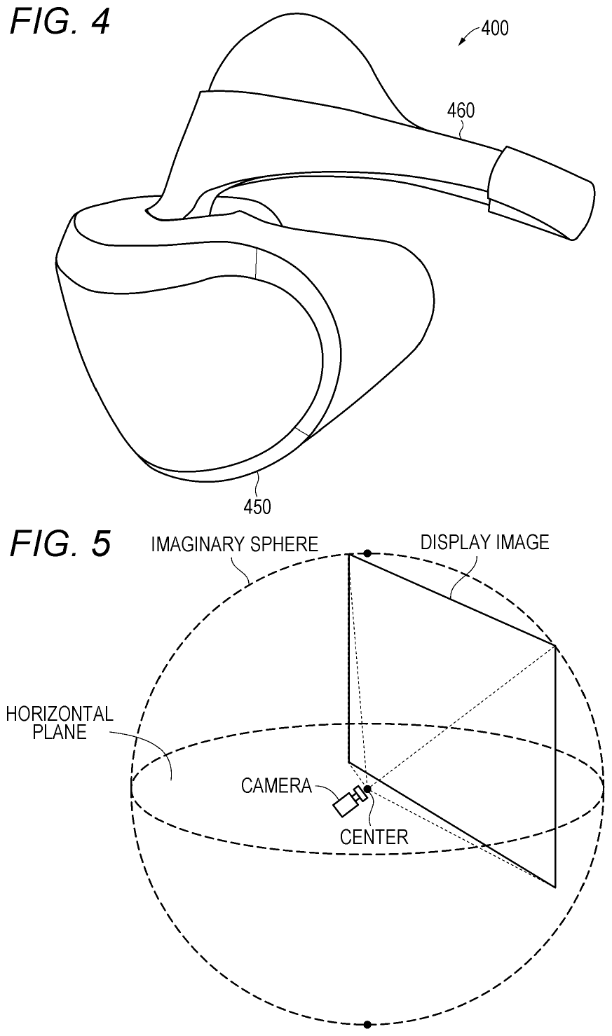

The head-mounted display 400 is worn by a user who uses the image processing system 10. The head-mounted display 400 corresponds to a display device in the claims. As illustrated in FIG. 4, the head-mounted display 400 includes a housing 450 and a band 460. The position sensor 410 is not illustrated. The head-mounted display 400 includes a liquid crystal display, an organic electroluminescence (EL) display, or the like, which is located in front of the user's eyes when worn, and displays a display image provided from the output device 300. A left-eye image is displayed on the left half of the display, and a right-eye image on the right half of the display, independently. The left-eye image and the right-eye image form parallax images viewed from left and right viewpoints, and can form a stereoscopic image by being displayed on the left and right areas of the display, respectively. Note that the head-mounted display 400 includes a central processing unit (CPU) or the like, and includes a control unit that performs control of the entire head-mounted display 400 such as image display control and operation control on the display, an external connection such as an HDMI (registered trademark) port or a USB port for connecting an external device, and others (not illustrated). Note that the head-mounted display 400 and the output device 300 may be connected by wireless communication instead of by wire. Note that the display device may be a mobile terminal such as a smartphone or a tablet terminal, instead of a head-mounted display. In a case where such a mobile terminal is used as the display device, a user usually uses an attachment having a band shape or other form that can be worn on the head, supporting the mobile terminal by setting or the like.

As described above, the head-mounted display 400 includes the position sensor 410 (the acceleration sensor and the gyro sensor) for providing position information to the output device 300. The position information is defined using rotation information (Yaw, Pitch, and Roll) in three-dimensional coordinates. The position sensor 410 detects the position of the head-mounted display 400, and transmits the detection results to the output device 300.

The image processing system 10 is configured as described above. As illustrated in FIG. 5, in the image processing system 10, the user wearing the head-mounted display 400 is imaginarily located at the center of a sphere. When the user changes his or her position, changing the direction or his or her line-of-sight, an image to be displayed is changed accordingly, thereby providing a virtual image world. The display image is pasted on the inner peripheral surface of the imaginary sphere centered around the user's location. The display image is formed by a stereo pair full spherical image captured by the omnidirectional camera 100, and is pasted on the inner peripheral surface of the imaginary sphere such that the top and bottom of the display image match the top and bottom of the imaginary sphere. Consequently, the top and bottom and left and right of the user's real world match the top and bottom and left and right of the image displayed on the head-mounted display 400, and realistic VR content is provided.

[1-2. Configuration and Processing of Content Server]

Next, with reference to FIG. 6, a configuration of the content server 200 will be described. The content server 200 includes a position-specific to-be-used camera table 210, a stereo pair full spherical image generation unit 220, and an image storage unit 230.

Captured images captured by the cameras included in the omnidirectional camera 100 and stored in the individual camera image recording unit 110 are provided from the omnidirectional camera 100 to the content server 200, and are provided to the stereo pair full spherical image generation unit 220 together with the position-specific to-be-used camera table 210.

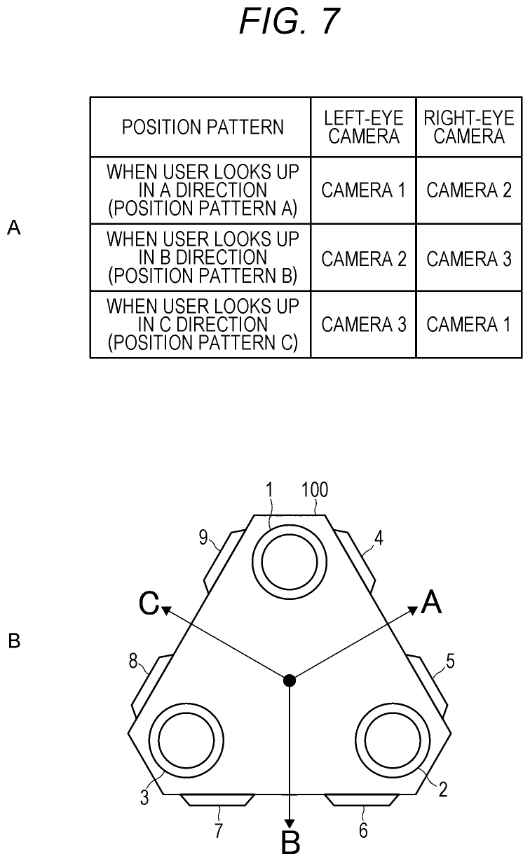

FIG. 7A illustrates an example of the position-specific to-be-used camera table 210. As illustrated in FIG. 7B, it is assumed that the user is imaginarily located at the approximate censer of the omnidirectional camera 100, and viewpoints from the approximate center of the omnidirectional camera 100 are expected. In the position-specific to-be-used camera table 210, a position in which the user looks up in an A direction from the omnidirectional camera 100, a position in which the user looks up in a B direction, and a position in which the user looks up in a C direction are associated with cameras to be used to create stereo pair full spherical images corresponding one-to-one to the directions. These can be said to be positions in a case where the user looks up in the A direction, the B direction, and the C direction from the approximate center of the omnidirectional camera 100.

The omnidirectional camera 100 illustrated in FIG. 2 includes the nine cameras. The camera 4, the camera 6, and the camera 8 are left-eye cameras, and the camera 5, the camera 7, and the camera 9 are right-eye cameras. The cameras 4 to 9 are cameras directed in the horizontal direction. Thus, cameras used as left-eye ones and right-eye ones do not change in any position pattern, and are always fixed. On the other hand, for the camera the camera 2, and the camera 3, cameras used as a left-eye one and a right-eye one change depending on a looking-up direction (a position pattern).

In the present embodiment, three directions are expected in a case where the user looks up in the A direction from the center of the omnidirectional camera 100 (a position pattern A), in a case where the user looks up in the B direction (a position pattern B), and in a case where the user looks up in the C direction (a position pattern C). Cameras to be used are as illustrated in the position-specific to-be-used camera table of FIG. 7A. For the position pattern A, the camera 1 is used as a left-eye camera, and the camera 2 is used as a right-eye camera. Furthermore, for the position pattern B, the camera 2 is used as a left-eye camera, and the camera 3 is used as a right-eye camera. Moreover, for the position pattern C, the camera 3 is used as a left-eye camera, and the camera 1 is used as a right-eye camera. Thus, in the present technology, a stereo pair full spherical image corresponding to each direction is generated, and thus cameras to capture viewpoint images for generating a stereo pair full spherical image are determined in advance for each direction. Note that the pair of cameras to be used and the direction to which the pair is assigned may be manually set according to the camera arrangement, or may be automatically set from the camera arrangement.

The position-specific to-be-used camera table 210 is preset in accordance with the cameras included in the omnidirectional camera 100 and the looking-up directions (position patterns), and stored in advance in the content server 200 as a table. The captured images and the position-specific to-be-used camera table 210 are provided to the stereo pair full spherical image generation unit 220.

The stereo pair full spherical image generation unit 220 generates position-specific stereo pair full spherical images on the basis of the captured images and the position-specific to-be-used camera table 210. Then, the generated position-specific stereo pair full spherical images are provided to and stored in the image storage unit 230 including a storage medium. The configuration to generate the stereo pair full spherical images corresponds to an image processing apparatus in claim 1 of the claims.

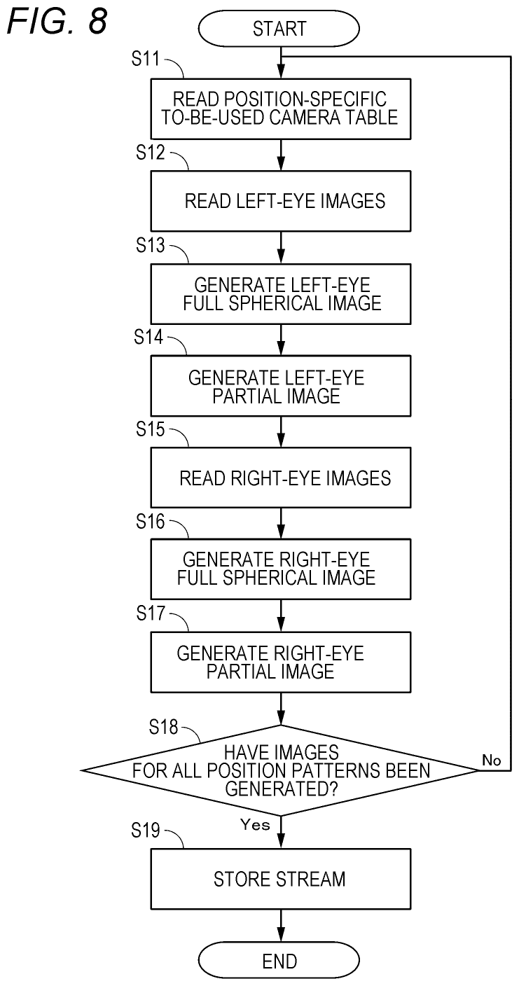

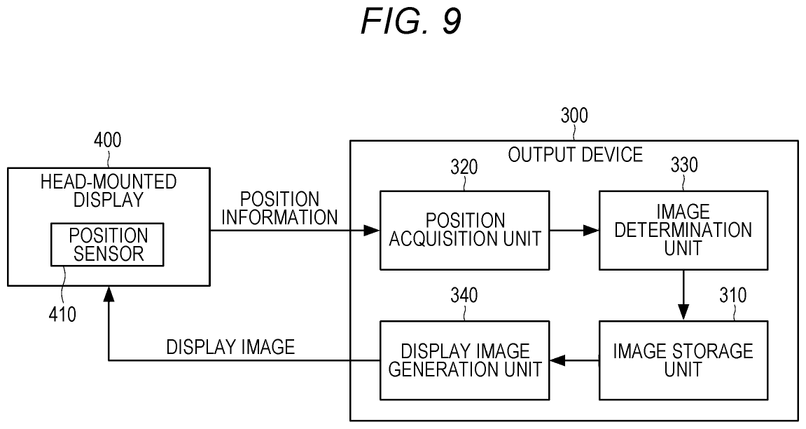

Next, processing performed by the stereo pair full spherical image generation unit 220 will be described with reference to a flowchart in FIG. 8. The stereo pair full spherical image generation processing is performed for each looking-up direction from the omnidirectional camera 100 (position pattern). In the present embodiment, there are three position patterns. Thus, stereo pair full spherical images are generated in the order of the position pattern A, the position pattern B, and the position pattern C. However, the generation order may be any order.

First, in step S11, the position-specific to-be-used camera table 210 is read. Next, in step S12, from the individual camera image recording unit 210, left-eye images captured by the left-eye cameras for the position pattern A from among the nine cameras constituting the omnidirectional camera 100 are read. For the position pattern A, images captured by the camera 1, the camera 4, the camera 6, and the camera 8 are read.

Next, in step S13, using the left-eye images captured by all the left-eye cameras, a left-eye full spherical image is generated by adjusting the brightness of the images and removing overlaps of the images to connect them by stitching.

Next, in step S14, a left-eye partial image is generated from the left-eye full spherical image. The partial image is generated by converting the left-eye full spherical image into a cube shape called cube mapping. Consequently, the full spherical image is divided into six-face images, and the partial image showing a part of the full spherical image is generated. By dividing the image, for example, the image generation processing in a case where the user looks upward can be performed only with an image of the +Y face of the cube map. Likewise, the image generation processing in a case where the user looks downward can be performed only with an image of the −Y face of the cube map. This eliminates the need to use the entire full spherical image in the image generation processing, allowing the speeding up of the processing, savings in the capacity of memory or a storage medium for holding images, and so on.

Subsequently, in step S15, from the individual camera image recording unit 210, right-eye images captured by the right-eye cameras for the position pattern A from among the nine cameras constituting the omnidirectional camera 100 are read. For the position pattern A, images captured by the camera 2, the camera 5, the camera 7, and the camera 9 are read.

Next, in step S16, a right-eye full spherical image is generated by stitching, using the right-eye images captured by all the right-eye cameras. Next, in step S17, a right-eye partial image is generated from the right-eye full spherical image. The partial image is generated in a similar manner as in step S14 in which the partial image is generated by dividing the left-eye full spherical image. The left-eye partial image and the right-eye partial image constitute a stereo pair full spherical image corresponding to the position pattern.

Then, in step S18, it is determined whether stereo pair full spherical images for all the position patterns have been generated. All the position patterns can be identified by referring to the position-specific to-be-used camera table 210. In a case where stereo pair full spherical images for all the position patterns have not been generated, the process proceeds to step S11 (No in step S18). Then, steps S11 to S18 are repeated until stereo pair full spherical images are generated for all the remaining position patterns.

In a case where stereo pair full spherical images for all the position patterns have been generated in step S18, the process proceeds to step S19 (Yes in step S18). Then, in step S19, all the stereo pair full spherical images are converted into an MPEG-DASH stream and stored in the image storage unit 230.

Note that although in the flowchart of FIG. 8, the left-eye image processing is performed first, and then the right-eye image processing is performed, the processing the left-eye images and the right-eye images is not limited to that order. The right-eye images may be read first to be processed.

Note that the generation of partial images is not essential processing in the stereo pair full spherical image generation processing in the flowchart of FIG. 8. Without performing division processing, full spherical images may be directly converted, into an MPEG-DASH stream and stored as stereo pair full spherical images.

[1-3 Configuration and Processing of Output Device]

Next, with reference to the configuration and processing of the output device 300 will be described. The output device 300 includes an image storage unit 310, a position acquisition unit 320, an image determination unit 330, and a display image generation unit 340. The output device 300 changes a stereo pair full spherical image generated by the content server 200 according to the position information of the head-mounted display 400 and outputs it to the head-mounted display 400.

The image storage unit 310 formed by a storage medium stores all the stereo pair full spherical images generated by decoding the MPEG-DASH stream transmitted from the content server 200 with a decoder. In the present embodiment, all the stereo pair full spherical images as content generated by the content server 200 are downloaded to the output device 300, stored in the output device 300, and then displayed on the head-mounted display 400. Note that instead of that, a streaming format may be used in which stereo pair full spherical images as content are displayed on the head-mounted display 400 while being transmitted from the content server 200 to the output device 300.

The position acquisition unit 320 acquires the position information of the head-mounted display 400 obtained by the position sensor 410, provided from the head-mounted display 400, and provides it to the image determination unit 330. The position information of the head-mounted display 400 is defined using rotation information (Yaw, Pitch, and Roll) in three-dimensional coordinates.

The image determination unit 330 determines a stereo pair full spherical image on the basis of the position information of the head-mounted display 400, and reads the determined stereo pair full spherical image from the image storage unit 310 in which all the stereo pair full spherical images are stored.

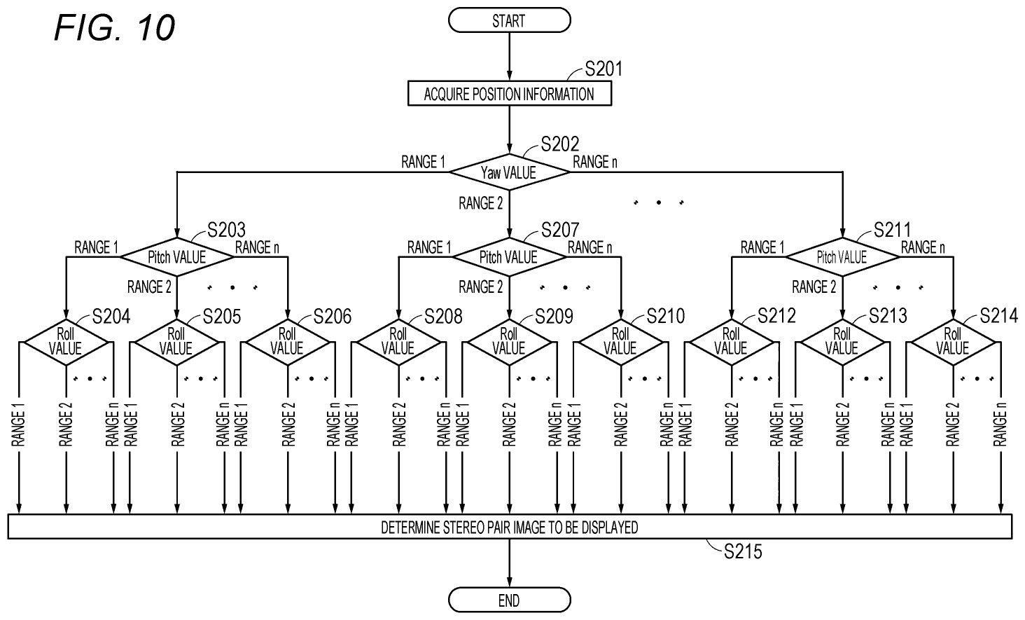

Here, with reference to a flowchart of FIG. 10, processing to determine a stereo pair full spherical image will be described. First, in step S201, the position acquisition unit 320 acquires position information from the head-mounted display 400. Next, in step S202, it is determined whether the Yaw value is in a first range, a second range, . . . , or an n-th range. Here, n corresponds to the maximum value of the number of position patterns. If there are three position patterns, the determination is the determination of the first range, the second range, and the third range, and the processing has three branches. If there are six position patterns, the determination is the determination of a first range, a second range, a third range, a fourth range, a fifth range, and a sixth range, and the processing has six branches. This also applies to Pitch and Roll.

In a case where the Yaw value is in the first range, it is determined in step S203 whether the Pitch value is in a first range, a second range, . . . , or an n-th range.

In a case where the Pitch value is in the first range in step S203, depending on whether the Roll value is in a first range, a second range, . . . , or an n-th range in step S204, a stereo pair full spherical image is determined in step S215.

Furthermore, in a case where the Pitch value is in the second range in step S203, depending on whether the Roll value is in the first range, the second range, . . . , or the n-th range in step S205, a stereo pair full spherical image is determined in step S215.

Moreover, in a case where the Pitch value is in the n-th range in step S203, depending on whether the Roll value is in the first range, the second range, . . . , or the n-th range in step S206, a stereo pair full spherical image is determined in step S215.

In a case where the Yaw value is in the second range in step S202, it is determined in step S207 whether the Pitch value is in the first range, the second range, . . . , or the n-th range.

In a case where the Pitch value is in the first range in step S207, depending on whether the Roll value is in the first range, the second range, . . . , or the n-th range in step S208, a stereo pair full spherical image is determined in step S215.

Furthermore, in a case where the Pitch value is in the second range in step S207, depending on whether the Roll value is in the first range, the second range, . . . , or the n-th range in step S209, a stereo pair full spherical image is determined in step S215.

Moreover, in a case where the Pitch value is in the n-th range in step S207, de ending on whether the Roll value is in the first range, the second range, . . . , or the n-th range in step S210, a stereo pair full spherical image is determined step S215.

In a case where the Yaw value is in the third range in step S202, it is determined in step S211 whether the Pitch value is in the first range, the second range, . . . , or the n-th range.

In a case where the Pitch value is in the first range in step S211, depending on whether the Roll value is in the first range, the second range, . . . , or the n-th range in step S212, a stereo pair full spherical image is determined in step S215.

Furthermore, in a case where the Pitch value is in the second range in step S211, depending on whether the Roll value is in the first range, the second range, . . . , or the n-th range in step S213, a stereo pair full spherical image is determined in step S215.

Moreover, in a case where the Pitch value is in the n-th range in step S211, depending on whether the Roll value is in th first range, the second range, . . . , or the n-th range in step S214, a stereo pair full spherical image is determined in step S215.

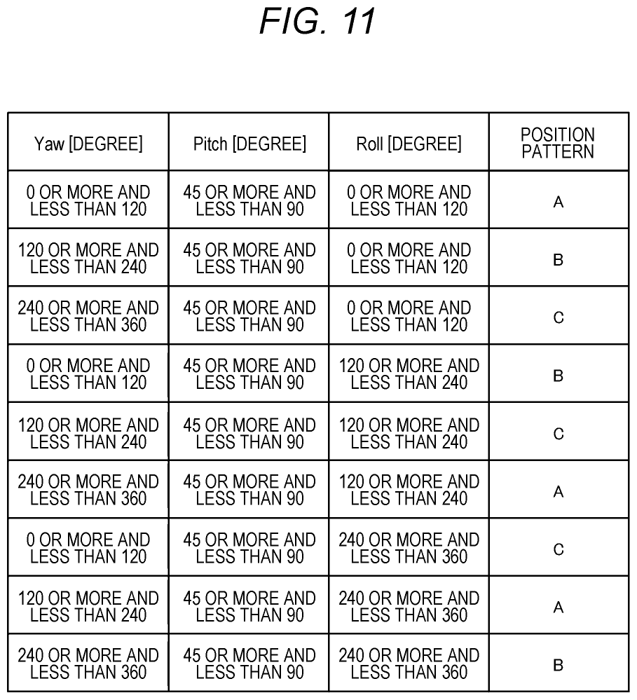

In the present embodiment, as illustrated in a table of FIG. 11, for the Yaw value, three ranges of 0 degrees or more and less than 120 degrees, 120 degrees or more and less than 240 degrees, and 240 degrees or more and less than 360 degrees are set. Further, the range of the Pitch value is set to a range of 45 degrees or more and less than 90 degrees. The Pitch range is fixed because the present technology is for performing image processing in a case where the user looks upward and the position of the head-mounted display 400 is oriented upward, using images captured by cameras directed upward. Moreover, for the Roll value, three ranges of 0 degrees or more and less than 120 degrees, 120 degrees or more and less than 240 degrees, and 240 degrees or more and less than 360 degrees are set. Then, the position patterns are associated with combinations of Yaw, Pitch, and Roll-in advance.

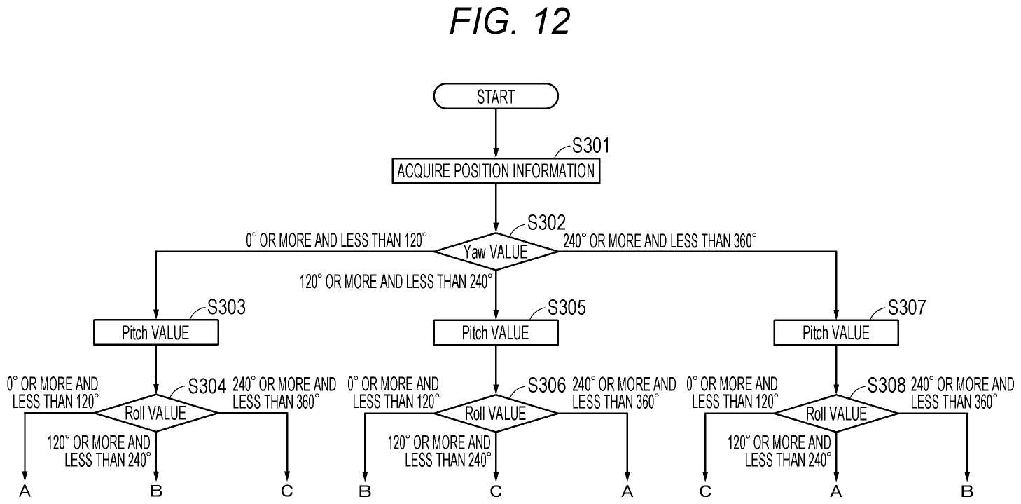

Accordingly, the application of the flowchart in FIG. 10 to the present embodiment results in that as illustrated in FIG. 12. In step S301, as in step S201, the position acquisition unit 320 acquires position information from the head-mounted display 400. Next, in step S302, it is determined whether the Yaw value is 0 degrees or more and less than 120 degrees, 120 degrees or more and less than 240 degrees, or 240 degrees or more and less than 360 degrees. In a case where the Yaw value is 0 degrees or more and less than 120 degrees, the process proceeds to step S303. In the present embodiment, since the range of the Pitch value is fixed, the process proceeds to step S304 without performing determination processing.

Then, in step S304, it is determined whether the Roll value is 0 degrees or more and less than 120 degrees, 120 degrees or more and less than 240 degrees, or 21 degrees or more and as than 360 degrees. In a case where the Roll value is 0 degrees or more and less than 120 degrees, a stereo pair full spherical image corresponds to the position pattern A. Furthermore, in a case where the Roll value is 120 degrees or more and less than 240 degrees, a stereo pair full spherical image corresponds to the position pattern B. Moreover, in a case where the Roll value is 240 degrees or more and less than 360 degrees, a stereo pair full spherical image corresponds to the position pattern C.

The description returns to step S302. In a case where the Yaw value is 120 degrees or more and less than 240 degrees in step S302, the process proceeds to step S305. In the present embodiment, since the range of the Pitch value is fixed, the process proceeds to step S306 without performing determination processing.

Then, in step S306, it is determined whether the Roll value is 0 degrees or more and less than 120 degrees, 120 degrees or more and less an 240 degrees, or 240 degrees or more and less than 360 degrees. In a case where the Roll value is 0 degrees or more and less than 120 degrees, a stereo pair full spherical image corresponds to the position pattern B. Furthermore, in a case where the Roll value is 120 degrees or more and less than 240 degrees, a stereo pair full spherical image corresponds to the position pattern C. Moreover, in a case where the Roll value is 240 degrees or more and less than 360 degrees, a stereo pair full spherical image corresponds to the position pattern A.

The description returns to step S302. In a case where the Yaw value is 240 degrees or more and less than 360 degrees in step S302, the process proceeds to step S307. In the present embodiment, since the range of the Pitch value is fixed, the process proceeds to step S308 without performing determination processing.

Then, in step S308, it is determined whether the Roll value is 0 degrees or more and less than 120 degrees, 120 degrees or more and less than 240 degrees, or 240 degrees or more and less than 360 degrees. In a case where the Roll value is 0 degrees or more and less than 120 degrees, a stereo pair full spherical image corresponds to the position pattern C. Furthermore, in a case where the Roll value is 120 degrees or more and less than 240 degrees, a stereo pair full spherical image corresponds to the position pattern A. Moreover, in a case where the Roll value is 240 degrees or more and less than 360 degrees, a stereo pair full spherical image corresponds to the position pattern B.

In this way, it is set in advance which stereo pair full spherical image is output to the head-mounted display 400 when the Yaw, Pitch, and Roll values are in which ranges. Note that it is necessary to make the number of final branches of the processing (in FIG. 12, the branches according to the Roll value) equal to the number of position patterns in advance. In a case where the number of position patterns is three, the number of final branches of the processing is also three. In a case where the number of position patterns is six, the number of final branches of the processing is also six.

When a stereo pair full spherical image is determined by the above processing, the image determination unit 330 reads the determined stereo pair full spherical image from the image storage unit 310 and provides it to the display image generation unit 340. The display image generation unit 340 generates a display image to be displayed on the head-mounted display 400 from the provided stereo pair full spherical image. The display image is a region of interest (ROI) area of the stereo pair full spherical image corresponding to the position of the head-mounted display 400.

For example, in a case where it is determined from the position information that the state of the head-mounted display 400 is the position pattern A, the stereo pair full spherical image corresponding to the position pattern A is read from the image storage unit 230. Then, an ROI area corresponding to the position of the head-mounted display 400 in the stereo pair full spherical image is set as a display image by the display image generation unit 340, and is provided to and displayed on the head-mounted display 400 as the display image. The configuration in which a display image is generated and provided to and displayed on the head-mounted display 400 corresponds to the image processing apparatus in claims 8 and 13 of the claims.

Note that an image read from the image storage unit 310 is not limited to a single stereo pair full spherical image. A plurality of stereo pair full spherical images may be read and composited by the display image generation unit 340 to use the composite image as a display image. This is to avoid the occurrence of displacements of an image due to sudden switching of images at the boundary of switching in a case where display images are switched according to the head position of the user wearing the head-mounted display 400.

For image composition, pixel blending of images to be switched such as alpha blending or multiband blending may be performed, or pixel warping may be performed using optical flow or the like to generate a middle image according to a position pattern.

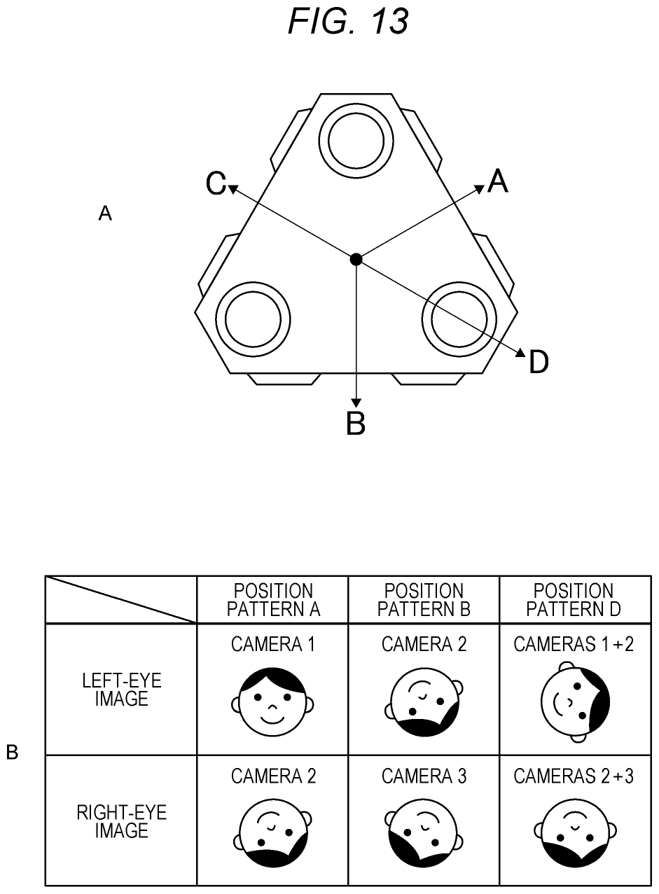

For example, as illustrated in FIG. 13A, in a case where the user looks up in a D direction (Yaw=120 degrees, Pitch=45 degrees, and Roll=0 degrees) which is a middle direction between the A direction and the B direction (a position pattern D), it is necessary to use a stereo pair full spherical image corresponding to the position pattern D as a display image. However, a left-eye camera and a right-eye camera corresponding to the position pattern D are not defined in the position-specific to-be-used camera table 210. Therefore, it is necessary to generate a new stereo pair full spherical image corresponding to the position pattern D by composition from the position pattern A and the position pattern B.

With reference to FIG. 13B, the composition of a stereo pair full spherical image will be described. Note that a person's faces corresponding to left-eye images and right-eye images of cameras in FIG. 13B are set for convenience of explanation of the image composition. As a method of generating a stereo pair full spherical image corresponding to the position pattern D by composition of the position pattern A and the position pattern B, for example, as illustrated in FIG. 13B, the amount of change from the left-eye image of the position pattern A to the left-eye image of the position pattern B is calculated by vector, using optical flow, and its middle is set as the left-eye image of the position pattern D. Likewise, the right-eye image of the position pattern D can be generated by composition of the right-eye image of the position pattern A and the right-eye image of the position pattern B. Thus, in a case where the position of the head-mounted display 400 is a position other than predefined positions, a composite image can be generated from two or more of the stereo pair full spherical images corresponding to the predefined positions of the head-mounted display 400, to obtain a display image corresponding to the position not predefined.

In a case where the looking-up direction is between the position pattern B and the position pattern C, a stereo pair full spherical image can be likewise generated by composition of the stereo pair full spherical images of the position pattern B and the position pattern C to generate a new stereo pair full spherical image corresponding to a new position pattern. Moreover, in a case where the user's head position is between the position pattern C and the position pattern A, a new stereo pair full spherical image can be likewise generated by composition of the stereo pair full spherical images of the position pattern C and the position pattern A to generate a stereo pair full spherical image corresponding to a new position pattern.

Then, the display image generated by the display image generation unit 340 is provided to and displayed on the head-mounted display 400 to be presented to the user. The processing in the present technology is performed as described above.

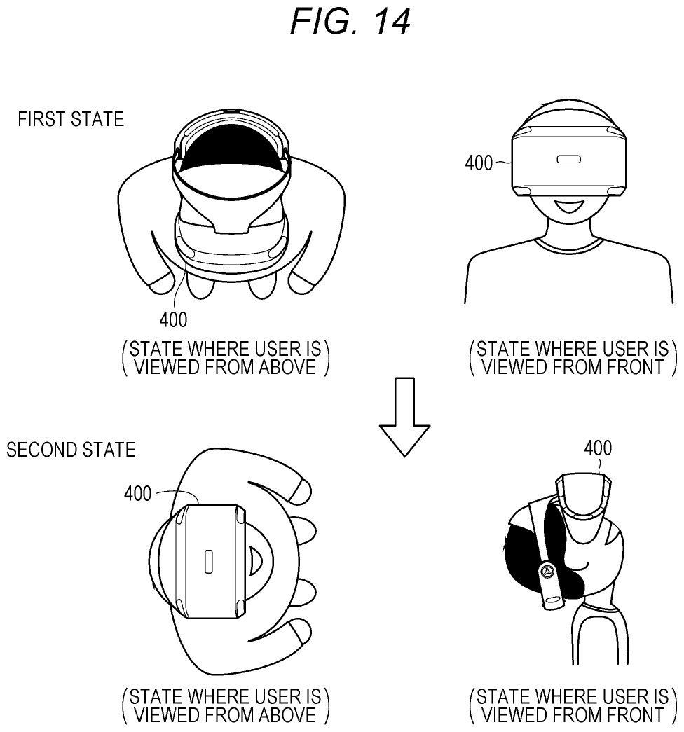

As illustrated in FIG. 14, if the user wearing the head-mounted display 400 in a first state of looking front (Yaw: 0 degrees, Pitch: 0 degrees, and Roll: 0 degrees) looks upward without turning (Yaw: 0 degrees, Pitch: 90 degrees, and Roll: 0 degrees), for example, the relationship between a right-eye image and a left-eye image of a stereo pair full spherical image does not break down, and thus left and right stereo views do not fail. However, in a case where the user turns from the first state to a second state (Yaw: 90 degrees, Pitch: 90 degrees, and Roll: 0 degrees), hitherto, the relationship between a right-eye image and a left-eye image of a stereo pair full spherical image has broken down, and left and right stereo views have failed. However, in the present technology, whatever values the rotation information (Yaw and Roll) of the head-mounted display 400 have in a looking-up state, a stereo pair full spherical image is generated in advance accordingly. Therefore, no matter into what state the orientation and position of the head-mounted display 400 change, including a change from the first state to the second state, an image can be displayed without causing failure in left and right stereo views.

The embodiment has described a case where cameras are directed upward, and position patterns are also oriented upward. However, by setting the Pitch value in the range of −45 degrees to −90 degrees, using images captured by cameras directed downward, a display image that does not fail even if the user's position changes can be displayed for a downward look likewise. For example, in a case where processing is further performed also on a downward look in the embodiment, a case where the user looks down in the A direction (a position pattern A′), a case where the user looks down in the B direction (a position pattern B′ and a case where the user looks down in the C direction (a position pattern C′) are set in addition to the case where the user looks up in the A direction (the position pattern A), the case where the user looks up in the B direction (the position pattern B), and the case where the user looks up in the C direction (the position pattern C).

As described above, in the horizontal direction, left and right stereo views do not fail no matter in what direction the user looks. Thus, in the horizontal direction, it is not necessary to create stereo pair full spherical images for various patterns using the present technology. By generating a partial image, for example, the image generation processing in a case where the user looks upward can be performed only with an image of the +Y face of the cube map. Likewise, the image generation processing in a case where the user looks downward can be performed only with an image of the −Y face of the cube map. This eliminates the need to use the entire full spherical image in the image generation processing, allowing the speeding up of the processing, savings in the capacity of memory or a storage medium for holding images, and so on.

In the present embodiment, the processing is performed only on positions in which the user looks upward, and no particular processing is performed as long as the head-mounted display 400 changes its direction while staying level. Consequently, the processing can be lightened, and further, the number of stereo pair full spherical images used for implementing the present technology can be reduced to reduce the capacity of a storage medium required for storing stereo par full spherical images.

Furthermore, it may be determined on what position the processing is performed according to the type of content. For example, in a case where content is concert video, the user usually gazes forward and upward at a stage, and does not look backward and downward much. Therefore, in this case, is not necessary to perform the processing of the present technology on lower images. This can reduce the processing load and increase the processing speed.

The function of the content server 200 and the function of the output device 300 according to the present technology may be provided by a program. The program may be preinstalled in the content server 200 and the output device 300, or may be downloaded or distributed on a storage medium or the like, and installed by the user himself or herself.

<2. Modifications>

Although the embodiment of the present technology has been specifically described above, the present technology is not limited to the above-described embodiment, and various modifications based on the technical idea of the present technology can be made.

Content displayed by the image processing system 10 is not limited to moving images, and may be still images. Further, content is not limited to images actually captured, and may be those drawn in real time by a game application.

For example, for content in which a scene with little change, such as the interior of a church or the interior of a museum is imaged, it can be said that still images rather than moving images are suitable. The reason is that moving images are not required because there is little change, and by displaying still images, the processing load can be reduced. Furthermore, by displaying still images, higher-resolution content can be provided to the user than in a case where moving images are displayed.

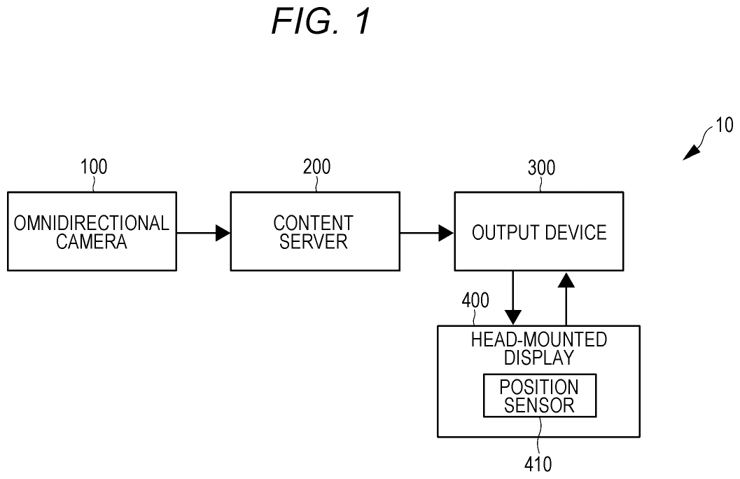

The image processing system 10 in FIG. 1 includes the content server 200 and the output device 300 connected to the content server 200 via the Internet or the like. However, instead of using the output device 300, the content server 200 may serve the function as the output device 300. In this case, the head-mounted display 400 is connected to the content server 200 via the Internet or the like, and position information obtained by the position sensor 410 of the head-mounted display 400 is transmitted to the content server 200. Then, the content server 200 determines a stereo pair full spherical image to be displayed, and transmits a display image in a streaming format to the head-mounted display 400 as the output device 300 in the embodiment performs.

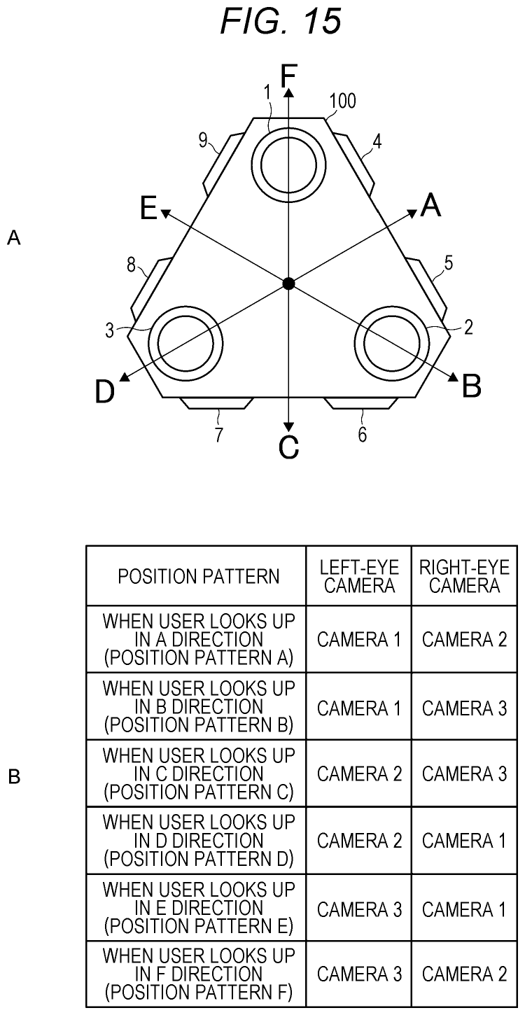

Although three position patterns, the position pattern A, the position pattern B, and the position pattern C, are set to perform the processing in the embodiment, the number of position patterns is not limited to three. For example, as illustrated in FIG. 15A, a total of six position patterns including a position pattern A, a position pattern B, a position pattern C, a position pattern D, a position pattern E, and a position pattern F may be set.

For the camera configuration and the position patterns illustrated in FIG. 15A, a position-specific to-be-used camera table needs to be preset to hold the six position patterns as illustrated in FIG. 15B. For example, for the position pattern A, a left-eye image is the camera 1, and a right-eye image is the camera 2. For the position pattern B, a left-eye camera is the camera 1, and a right-eye camera is the camera 3. For the position pattern C, a left-eye camera is the camera 2, and a right-eye camera is the camera 2. For the position pattern D, a left-eye camera is the camera 2, and a right-eye camera is the camera 1. For the position pattern E, a left-eye camera is the camera 3, and a right-eye camera is the camera 1. For the position pattern F, a left-eye camera is the camera 3, and a right-eye camera is the camera 2.

In this case, the number of images to be held is that of three cameras as in the description of the embodiment. However, by hanging combinations of left eye cameras and right-eye cameras, stereo pair full spherical images can be switched in smaller units, allowing image display with less parallax failure. In this case, display switching in accordance with changes in Yaw, Pitch, and Roll is performed with Yaw and Roll in the table of FIG. 11 each halved in angle units, quadrupling the number of patterns.

Furthermore, in the embodiment, the number of cameras directed upward in the omnidirectional camera 100 is set to three for explanatory convenience, but the number of cameras is not limited to that. Increasing the number of cameras allows switching of stereo pair full spherical images in smaller units, and thus allows more natural stereo views. Moreover, although the cameras directed upward have been described for explanatory convenience, the direction of cameras is not limited to an upward direction (looking-up direction) or a downward direction (looking-down direction), and may be any direction including a horizontal one. Particularly, using a stereo pair full spherical image in the up-and-down direction in the horizontal direction allows the user wearing the head-mounted display 400 to view with failure being prevented or with failure being reduced, even when viewing with the head tilted, or down, tilting the head.

Thus, a stereo pair full spherical image can be generated for each finer range, so that more natural and smoother switching can be achieved when the position of the head-mounted display 400 is changed and stereo pair full spherical images are switched accordingly. Note that the number of position patterns not limited to six, and may be more or less.

Note that the output device 300 may be configured integrally with the head-mounted display 400.

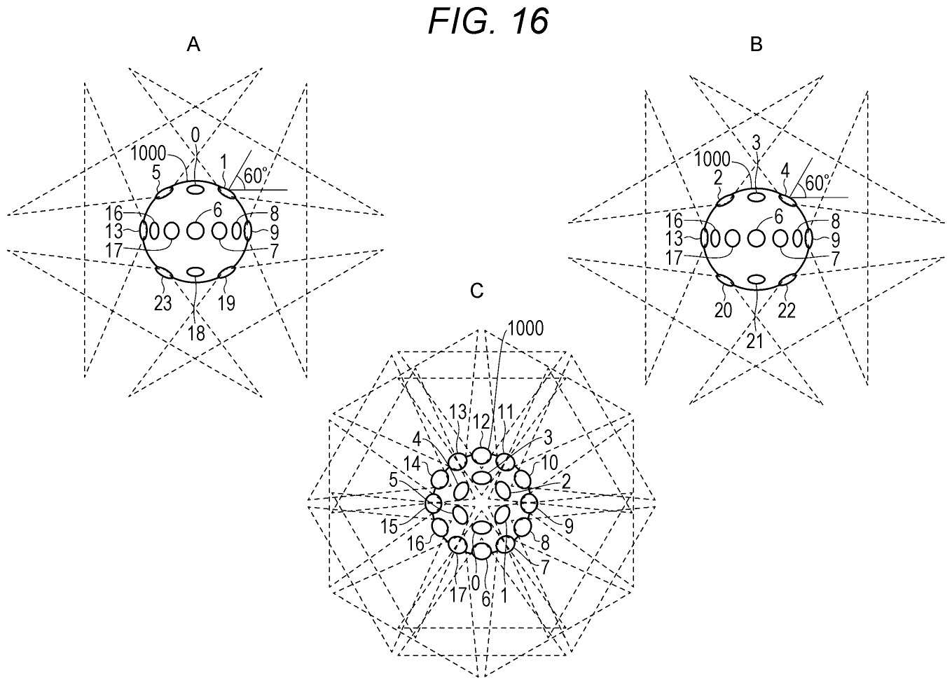

Moreover, an omnidirectional camera 1000 using wide-angle lenses according to a modification is illustrated in FIG. 16. As a camera arrangement in which all 360-degree directions can be imaged by multiple camera pairs, using wide-angle small cameras (with a horizontal angle of view of 135 degrees and a vertical angle of view of 70 degrees) with an aspect ratio of 16: 9, a configuration illustrated in FIG. 16 can be employed.

Using a total of twenty-four cameras of a camera 0 to a camera 23 enables imaging in all 360-degree directions. The twenty-four cameras include six cameras corresponding to 60 degrees latitude, six cameras corresponding to −60 degrees latitude, and twelve cameras at 0 degrees latitude.

With this camera configuration, for upper directions, stereo pair full spherical images in different directions can be generated by a camera 0-camera 1 pair, a camera 1-camera 2 pair, a camera 2-camera 3 pair, a camera 3-camera 4 pair, and a camera 4-camera 5 pair.

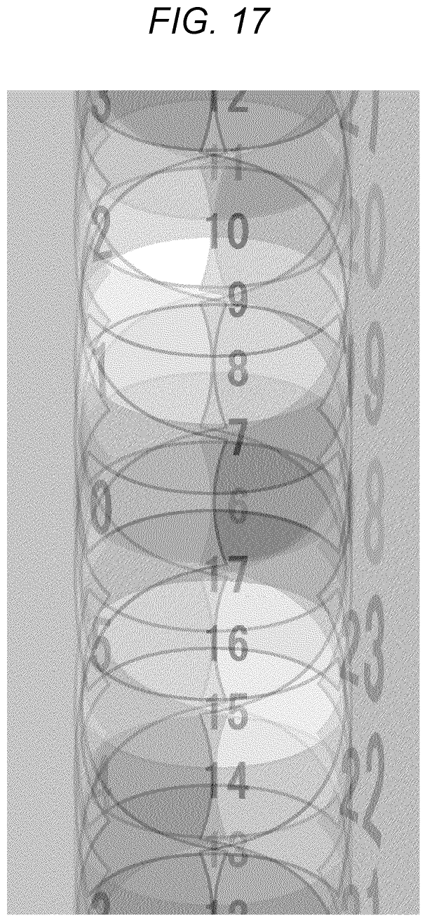

FIG. 17 schematically illustrates the angles of view of the cameras included in the omnidirectional camera 1000 illustrated in FIG. 16. Numbers in FIG. 17 represent the angles of view of the camera 0 to the camera 23 included in the omnidirectional camera 1000 illustrated in FIG. 16. For example, for the angles of of the camera 6 and the camera 7, their overlapping portion includes the angle of view of the camera 0. Thus, in a case where the user is looking in a horizontal direction in the first state illustrated in FIG. 14, and the position of the head-mounted display 400 is substantially horizontal (Pitch=−45 degrees to +45 degrees), a left-eye camera is the camera 6, and a right-eye camera is the camera 7. Then, in a case where the user looks upward (Pitch=45 degrees to 90 degrees) and changes the orientation of the body (for example, Yaw=90 degrees) in the second state illustrated in FIG. 14, a left-eye camera is set to the camera 0 and a right-eye camera is set to the camera 6. Since there is an overlap between the camera 6 and the camera 7, and also there is an overlap between the camera 0 and the camera 6 in the same area, cameras to be used can be switched to continuously generate an image in the same area. Thus, a left and right stereo pair can be prevented from failing.

The present technology can also take the following configurations.

(1)

An image processing apparatus generating stereo pair full spherical images corresponding to a plurality of positions of a display device, on the basis of two or more viewpoint images for each position determined in accordance with the plurality of positions of the display device, from a plurality of viewpoint images captured at different locations.

(2)

The image processing apparatus according to (1), in which the plurality of positions includes states of at least looking up and/or looking down in a plurality of predetermined directions.

The image processing apparatus according to (1) or (2), in which the plurality of positions includes states in which the display device is at least tilted.

(4)

The image processing apparatus according to any one of (1) to (3), in which the stereo pair full spherical images include a plurality of full spherical images corresponding to the plurality or positions.

(5)

The image processing apparatus according to any one of (1) to (3), in which the stereo pair full spherical images include partial images showing a part of a full sphere.

(6)

The image processing apparatus according to any one of (1) to (5), in which the two or more viewpoint images are determined by referring to a table in which each position is associated with the locations in advance.

(7)

An image processing method including generating stereo pair full spherical images corresponding to a plurality of positions of a display device, on the basis of two or more viewpoint images for each position determined in accordance with the plurality of positions of the display device, from a plurality of viewpoint images captured at different locations.

(8)

An image processing program causing a computer to execute an image processing method including generating stereo pair full spherical images corresponding to a plurality of positions of a display device, on the basis of two or more viewpoint images for each position determined in accordance with the plurality of positions of the display device, from a plurality of viewpoint images captured at different locations.

(9)

An image processing apparatus including:

a position acquisition unit that acquires a position of a display device;

an image determination unit that selects at least one stereo pair full spherical image from a plurality of stereo pair full spherical images generated from a plurality of viewpoint images captured at different locations, on the basis of a plurality of positions of the display device; and

an image generation unit that generates a display image to be displayed on the display device on the basis of the selected stereo pair full spherical image.

(10)

The image processing apparatus according to (9), in which the position of the display device is defined by rotation information (Yaw, Pitch, and Roll) of the display device.

(11)

The image processing apparatus according to (9) or (10), in which the image generation unit generates a composite image as the display image from two or more of the stereo pair full spherical images corresponding to predefined positions of the display device, in a case where the position of the display device is a position other than the predefined positions.

(12)

An image processing method including:

acquiring a position of a display device;

selecting at least one stereo par full spherical image from a plurality or stereo pair full spherical images generated from a plurality of viewpoint images captured at different locations, on the basis of a plurality of positions of the display device; and

generating a display image to be displayed on the display device on the basis of the selected stereo pair full spherical image.

(13)

An image processing program causing a computer to execute an image processing method including:

acquiring a position of a display device;

selecting at least one stereo pair full spherical image from a plurality of stereo pair full spherical images generated from a plurality of viewpoint images captured at different locations, on the basis of a plurality of positions of the display device; and

generating a display image to be displayed on the display device on the basis of the selected stereo pair full spherical image.

(14)

An image processing apparatus causing a display device to display as a display image at least one stereo pair full spherical image selected on the basis of a position of the display device, from a plurality of stereo pair full spherical images generated according to a plurality of positions of the display device on the basis of two or more viewpoint images selected from a plurality of viewpoint images captured at different locations.

(15)

The image processing apparatus according to claim (14), in which the image processing apparatus causes the display device to display as the display image an image into which two or more of the stereo pair full spherical images corresponding to predefined positions of the display device are composited, in a case where the position of the display device is a position other than the predefined positions.

(16)

The image processing apparatus according to (14) or (15), in which the stereo pair full spherical images include full spherical images corresponding to the plurality of positions.

(17)

The image processing apparatus according to claim (14) or (15), in which the stereo pair full spherical images include partial images showing a part of a full sphere.

(18)

An image processing method including displaying on a display device as a display image at least one stereo pair full spherical image selected on the basis of a position of the display device, from a plurality of stereo pair full spherical images generated according to a plurality of positions of the display device on the basis of two or more viewpoint images selected from a plurality of viewpoint images captured at different locations.

(19)

An image processing program causing a computer to execute an image processing method including

displaying on a display device as a display image at least one stereo pair full spherical image selected on the basis of a position of the display device, from a plurality of stereo pair full spherical images generated according to a plurality of positions of the display device on the basis of two or more viewpoint images selected from a plurality of viewpoint images captured at different locations.

### REFERENCE SIGNS LIST

100 Omnidirectional camera

200 Content server

300 Output device

400 Head-mounted display

1. An image processing apparatus generating stereo pair full spherical images corresponding to a plurality of positions of a display device, on a basis of two or more viewpoint images for each position determined in accordance with the plurality of positions of the display device, from a plurality of viewpoint images captured at different locations.

2. The image processing apparatus according to claim 1, wherein
the plurality of positions includes states of at least looking up and or looking down in a plurality of predetermined directions.

3. The image processing apparatus according to claim 1, wherein
the plurality of positions includes states in which the display device is at least tilted.

4. The image processing a para s according to claim 1, wherein
the stereo pair full spherical images comprises a plurality of full spherical images corresponding to the plurality of positions.

5. The image processing apparatus according to claim 1, wherein
the stereo pair full spherical images comprise partial images showing a part of a full sphere.

6. The image processing apparatus according to claim 1, wherein
the two or more viewpoint images are determined by referring to a table in which each position is associated with the locations in advance.

7. An image processing method comprising
generating stereo pair full spherical images corresponding to a plurality of positions of a display device, on a basis of two or more viewpoint images for each position determined in accordance with plurality of positions of the display device, from a plurality of viewpoint images captured at different locations.

8. An image processing program causing a computer to execute an image processing method comprising
generating stereo pair full spherical images corresponding to a plurality of positions of a display device, on a basis of two or more viewpoint images for each position determined in accordance with the plurality of positions of the display device, from a plurality of viewpoint images captured at different locations.

9. An image processing apparatus comprising:
a position acquisition unit that acquires a position of a display device;
an image determination unit that determines at least one stereo pair spherical image from a plurality of stereo pair full spherical images generated from a plurality of viewpoint images captured at different locations, on a basis of a plurality of positions of the display device; and
an image generation unit that generates a display image to be displayed on the display device on a basis of the determined stereo pair full spherical image.

10. The image processing apparatus according to claim 9, wherein
the position of the display device is defined by rotation information (Yaw, Pitch, and Roll) of the display device.

11. The image processing apparatus according to claim 9, wherein
the image generation unit generates a composite image as the display image from two or more of the stereo pair full spherical images corresponding to predefined positions of the display device, in a case where the position of the display device is a position other than defined positions.

12. An image processing method comprising:
acquiring a position of a display device;
determining at least one stereo pair full spherical image from a plurality of stereo pair full images generated from a plurality of viewpoint images captured at different locations, on a basis of a plurality of positions of the display device; and
generating a display image to be displayed on the display device on, a basis of the determined stereo pair full spherical image.

13. An image processing program causing a computer to execute an image processing method comprising:
acquiring a position of a display device;
determining at least one stereo pair full spherical image from a plurality or stereo pair full spherical images generated from a plurality of viewpoint images captured at different locations, on a basis of a plurality of positions of the display device; and
generating a display image to be displayed on the display device on a basis of the determined stereo pair full spherical image.

14. An image processing apparatus causing a display device to display as a display image at least one stereo pair full spherical image determined on a basis of a position of the display device, from a plurality of stereo pair full spherical images generated according to a plurality of positions of the display device on a basis of two or more viewpoint images selected from a plurality of viewpoint images captured at different locations.

15. The image processing apparatus according to claim 13, wherein
the image processing apparatus causes the display device to display as the display image an image into which two or more of the stereo pair full spherical images corresponding to predefined positions of the display device are composited, in a case where the position of the display device is a position other than the predefined positions.

16. The image processing apparatus according to claim 14, wherein
the stereo pair full spherical images comprise full spherical images corresponding to the plurality of positions.

17. The image processing apparatus according to claim 14, wherein
the stereo pair full spherical images comprise partial images showing a part of a full sphere.

18. An image processing method comprising
displaying on a display device as a display image at least one stereo pair full spherical image determined on a basis of a position of the display device, from a plurality of stereo pair full spherical images generated according to a plurality of positions of the display device on a basis of two or more viewpoint images selected from a plurality of viewpoint images captured at different locations.

19. An image processing program causing a computer to execute an image processing method comprising
displaying on a display device as a display image at least one stereo pair full spherical image determined on a basis of a position of the display device, from a plurality of stereo pair full spherical images generated according to a plurality of positions of the display device on a basis of two or more viewpoint images selected from a plurality of viewpoint images captured at different locations.
